(19) United States
(12) Patent Application Publication
(10) Pub. No.: US 2024/0150923 A1
(43) Pub. Date: May 9, 2024

(54) METHOD, HOLDER AND ADAPTER FOR TREATING MICROCHIP SUBSTRATES

(71) Applicant: MTI GMBH, Villach (AT)

(72) Inventor: Markus HACKSTEINER, Villach (AT)

(21) Appl. No.: 18/548,773

(22) PCT Filed: Feb. 16, 2022
(86) PCT No.: PCT/EP2022/053812

§ 371 Date: Sep. 1, 2023

(30) Foreign Application Priority Data
Mar. 2, 2021 (AT) A 60058/2021

(51) Int. Cl. C25D 17/00; C25D 17/08

(52) U.S. Cl. CPC C25D 17/001; C25D 17/004; C25D 17/005; C25D 17/08

(57) ABSTRACT

Described is a method for wet-chemical treatment of microchip substrates, wherein the microchip substrates are inserted into a holding device. The holding device is docked using an adapter onto a unit for wet-chemical treatment, such as metallization.

### CROSS-REFERENCE TO RELATED APPLICATIONS

This application is the US national stage of PCT/EP2022/053812, filed Feb. 16, 2022 and designating the United States, which claims the priority of AT A 60058/2021, filed Mar. 2, 2021. The entire contents of each foregoing application are incorporated herein by reference.

### BACKGROUND OF THE INVENTION

### Field of the Invention

The invention relates to a method for wet-chemical treatment of a microchip substrate.

The invention also relates to a holding device, which can be used when implementing the method according to the invention.

The invention also relates to an adapter, with which the holding device according to the invention can be coupled to an electrolytic metallizing unit.

### Description of the Related Art

Known from WO 2020/169439 A1 is an arrangement for making electrical contact with a microchip substrate during electrolytic metallization. The known arrangement comprises a holding device with a recess, to which underpressure can be applied, for receiving the microchip substrate and a busbar. Electrical contact arranged in the area of the outside edge of the microchip substrate is provided, which contact is electrically connected to the face of the microchip substrate and the busbar. The electrical contact designed as a ring or as multiple strips is kept in contact with the microchip substrate and the busbar by a layer that abuts its side that faces away from the microchip substrate. The layer extends over the edge of the microchip substrate and beyond the busbar and reaches up to the holding device. After metallization, the layer can be detached from the microchip substrate.

The wet-chemical treatments in question for the invention can be an electrolytic metallization, an electrochemical etching, an electrochemical cleaning, or an electrochemical conditioning of microchip substrates, such as wafers or panels.

For a wet-chemical treatment, microchip substrates must often make electrical contact, and the electrical contacts must be sealed. In addition, in the case of a wet-chemical treatment, such as during metallization of microchip substrates, the edge of the substrate must be sealed.

In the state of the art published before WO 2020/169439 A1, making contact and sealing are done by means of clamping devices. The sealing of the edge of the microchip substrate is done by pressing a chemically-resistant elastomer (e.g., lip seal). The force necessary for this purpose is, for example, 1000 N to ensure that sealing is achieved. So that such high forces can be applied, the hardware components must have a sturdy design. This inevitably leads to a pronounced topography level on the edge of the microchip substrate, as soon as the latter is clamped (cf. FIG. 9, upper view). A similar topography level is produced in the case of the clamping device known from US 2017/0073832 A1.

A pronounced topography level on the edge of the microchip substrate leads to a disruption of the flow of the liquid medium, e.g., of the electrolyte, that is used during wet-chemical treatments, which is disadvantageous for a uniform treatment, for example during coating, and limits the speed of the coating.

Starting from WO 2020/169439 A1, the object of the invention is to improve the reliability of the seal and to make available a method as well as devices, in particular a holding device for a microchip substrate as well as an adapter for the holding device, in which the technology of WO 2020/169439 A1 can be applied.

### SUMMARY OF THE INVENTION

This object is achieved according to the invention with a method that has the features disclosed and claimed.

Preferred and advantageous configurations of the method according to the invention are also disclosed and claimed.

Since, in the method according to the invention, a polymer film is applied onto the holding device and the microchip substrate, a reliable seal is produced, wherein at the same time, the mechanical stress on the edge of the microchip substrate is reduced since lesser force must be applied in order to achieve an adequate seal.

This applies in particular when polymer film is fastened to the holding device and the microchip substrate by gluing.

In the embodiments, the invention provides, i.a., one or more of the advantages mentioned below:
An improved process quality on the edge of the microchip substrates,
An increase in productivity of units for treating microchip substrates,
An improved systematic yield of microchips per microchip substrate, and
An improved adaptability of units for fashioning microchip substrates to the size and the geometry of microchip substrates.

The method according to the invention differs significantly from the known methods in

which in the case of treating wafers in an electrolytic metallizing unit, a cartridge with wafers is docked onto a unit for electrolytic metallization. The metallizing device extracts the wafer from the cartridge and puts each individual wafer into a wafer holding device. The wafer holding devices are intermediately stored in the metallizing unit. As soon as a metallizing cell is free, the coating process is begun. After metallization, the wafer holding devices are unloaded inside the metallizing unit, and the wafers are delivered to the docked cartridge.

In the method according to the invention, it is possible to use holding devices according to the invention, provided for this purpose, for the microchip substrates to be treated, which substrates are loaded into a stand-alone unit, provided with polymer film, and intermediately stored. For example, after the wet-chemical treatment, the polymer film is removed, and the microchip substrate is extracted from the holding device.

In this case, in the method according to the invention, it can be provided that the stand-alone unit parts for filming/defilming (applying and removing polymer film) are arranged and interconnected in such a way that the loaded holding devices for microchip substrates can be delivered (and returned) directly to the wet-chemical treatments, e.g., an electrolytic metallizing device. If the stand-alone filming/defilming devices are arranged at a distance from one another and/or at a distance from a unit for wet-chemical treatment, the microchip substrates accommodated in holding devices are transported to the wet-chemical treatment, e.g., to the electrolytic metallizing devices, and then transported back again.

In this case, the option also exists for supplying multiple electrolytic (metallizing) units for wet-chemical treatment with holding devices equipped with microchip substrates.

Below, exemplary features of the method according to the invention are indicated, each of which may be essential to the invention by itself or in combination with at least one additional feature:

The method uses stand-alone filming/defilming units, whose timing is isolated in time from the processes in the wet units (e.g., units for electrolytic metallization).

The method encompasses the fact that the filming/defilming unit can be used for diverse wet-chemical applications, not only for an electrolytic metallization.

Wet-chemical applications can be: electrolytic metallization, wet-chemical etching, galvanic (=without external current) metallization, wet-chemical cleaning.

The method uses a holding device for the microchip substrate, which is transported back and forth between the wet unit, on the one hand, and the stand-alone filming/defilming unit, on the other hand.

The method makes possible a complete decoupling of the work steps “loading/unloading the holding device” and “electrolytic or wet-chemical treatment.”

The method comprises a step where the holding device is loaded with a microchip substrate (e.g., wafer) in the filming/defilming unit, filmed corresponding to the subsequent wet-chemical treatment, and optionally intermediately stored. The loaded holding device is delivered to the wet unit on demand by the software of the production control unit. After the wet-chemical process, the return transport and then the defilming and extraction of the microchip substrate from the holding device take place.

The method offers the option of a central intermediate storage of loaded holding devices.

In the case of a filming by lamination, the method makes it possible for a laser to be used for introducing heat, which is necessary for lamination.

The method uses a laser for cutting the polymer film(s) used.

The method uses a laser for defilming.

The method makes it possible for vacuum-lamination to be done.

The method makes it possible for the film(s) to be pressed during lamination with a die, transparent to laser light, on the microchip substrate and the holding device.

The method comprises a step where the polymer film(s) is/are pressed with a roller.

The method comprises a step where in the filming/defilming unit, simultaneous suctioning-off is done in the case of at least one of the work steps.

The method comprises a step where at least one of the work steps can be carried out in the filming/defilming unit under cover gas (inert gas).

The method comprises a step where at least one of the work steps can be carried out in the filming/defilming unit under underpressure.

The method comprises a step where the polymer film(s) is/are cut after (local) gluing.

The method comprises a step where before (local) gluing, the polymer film(s) is/are cut either in the filming/defilming unit or externally.

The method makes it possible for defilming either thermally (e.g., by laser) and/or mechanically by peeling, and/or chemically by detachment.

The method makes it possible for an adapter according to the invention to be used, with which adapter an existing wet unit, such as, e.g., a Raider™ unit (electrolytic metallizing unit of Applied Materials, Inc.), can be used for the method according to the invention and the holding device according to the invention.

The method can be executed in a clean room.

The method comprises a step where for filming, a polymer film (plastic film) that has been coated with at least one electric strip conductor is used.

The method comprises a step where Inkjet printing or silk-screening is used for coating the strip conductor.

The method comprises a step where for the coating of the strip conductor, first a base layer is printed that is made of an electrically-conductive polymer, and in a second step, a thicker metallic strip conductor (e.g., made of copper) is applied electrolytically onto the printed base layer.

The method comprises a step where for the coating of the strip conductor, first a base layer made of carbon is printed, and in a second layer, a thicker metallic strip conductor (e.g., made of copper) is applied electrolytically onto this base layer.

The method comprises a step where the strip conductor (e.g., made of copper) is applied galvanically (=without external current), just as in the plastic metallization of components, as is carried out in, e.g., the automobile industry, on a previously-conditioned partial surface of the polymer film (plastic film).

The method comprises a step where the electrical conductor used is a conductor film that is depressed by the polymer film onto the microchip substrate.

The method makes it possible for the electrical conductor film to be provided at least on one side with an electrically-conductive adhesive.

The method makes it possible for a dry-lacquer film (“dry resist film”) to be used as a polymer film.

The method encompasses the fact that a dry-lacquer film, as described above, is coated locally with at least one strip conductor.

The method comprises a step where a dry-lacquer film, coated with at least one strip conductor, is used for filming within the framework of the method according to the invention.

The method comprises a step where in one work step, a dry-lacquer film (after a protective film is peeled off) is laminated over the entire surface on the microchip substrate and on the surface of the holding device surrounding the microchip substrate.

The method makes it possible for filming to be executed with a conventional roller lamination device. This device can be part of the filming/defilming unit, or else separate.

The method comprises a step where a defilming at least of the holding device is executed.

The method comprises a step where the microchip substrate after the extraction from the holding device is additionally cleaned (e.g., by means of plasma or by means of a liquid).

The method comprises a step where the holding device is cleaned at least from time to time (for example, by means of plasma or by means of a liquid).

The method comprises a step where both sides of the microchip substrate are filmed.

The method can be used, e.g., even in the case of electrochemical research works, in which, e.g., rotating disk electrodes are used.

In particular, in the case of the invention, the method steps listed below can be carried out:

In one embodiment of the invention, it is provided that the polymer film is applied onto the microchip substrate either while leaving free at least one area of the microchip substrate to be treated or over the entire surface with subsequent removal of the polymer film from at least one area of the microchip substrate to be treated.

In one embodiment of the invention, it is provided that the polymer film is attached when it is glued on.

In one embodiment of the invention, it is provided that the polymer film is attached with the input of heat and application of pressing force.

In one embodiment of the invention, it is provided that heat is generated by means of laser radiation.

In one embodiment of the invention, it is provided that the pressing force is applied by generating a pressure difference between the surfaces of the polymer film.

In one embodiment of the invention, it is provided that the pressing force is applied using a die.

In one embodiment of the invention, it is provided that a laser-permeable die is used.

In one embodiment of the invention, it is provided that the removal of polymer film is executed under cover gas and/or suctioning-off.

In one embodiment of the invention, it is provided that the polymer film is applied, in particular glued, in the area of the outer edge of the microchip substrate while leaving free the central area of the microchip substrate.

In one embodiment of the invention, it is provided that a polymer film is used, which film has a strip conductor.

In one embodiment of the invention, it is provided that a polymer film is used, which film as a strip conductor has a conductor film comprising a carrier film and at least one electrically-conductive layer, for example made of metal, in particular copper.

In one embodiment of the invention, it is provided that a conductor film is used, which has two electrically-conductive layers, between which a carrier film is provided (lies).

In one embodiment of the invention, it is provided that the holding device is docked with an inserted microchip substrate onto a device for executing the wet-chemical treatment.

In one embodiment of the invention, it is provided that as a polymer film, a dry-lacquer film is used.

In one embodiment of the invention, it is provided that the dry-lacquer film is applied over the entire surface of the microchip substrate and that the dry-lacquer film is removed before the wet-chemical treatment from the at least one area of the microchip substrate to be treated.

In one embodiment of the invention, it is provided that the dry-lacquer film is structured with lithography processes in order to partially remove the dry-lacquer film.

In one embodiment of the invention, it is provided that as a wet-chemical treatment, an electrolytic metallization, an electrochemical etching, an electrochemical cleaning, or an electrochemical conditioning is carried out.

In one embodiment of the invention, it is provided that a polymer film is used, which film as a strip conductor carries an annular, for example circular, conductor film.

In one embodiment of the invention, it is provided that the annular conductor film is connected to the polymer film by gluing.

In one embodiment of the invention, it is provided that the polymer film and/or the conductor film is/are laser-trimmed.

In one embodiment of the invention, it is provided that the polymer film is cut before or after the application.

In one embodiment of the invention, it is provided that the removal of the polymer film is done by laser.

In one embodiment of the invention, it is provided that the polymer film is removed chemically or mechanically.

In one embodiment of the invention, it is provided that at least one edge of the microchip substrate is cleaned after the polymer film is removed.

In one embodiment of the invention, it is provided that the cleaning is done by means of lasers.

In one embodiment of the invention, it is provided that the face, the back side, and the edge of the microchip substrate are cleaned.

In one embodiment of the invention, it is provided that the holding device is loaded with two microchip substrates.

A holding device according to the invention, which can be used when carrying out the method according to the invention is disclosed and claimed.

Preferred and advantageous configurations of the holding device according to the invention are also disclosed and claimed.

In one embodiment of the holding device according to the invention, it can be provided that the base plate is connected, in particular glued, to the frame.

In one embodiment of the holding device according to the invention, it can be provided that in the base plate, at least one opening is provided, which opening is covered by the frame.

In one embodiment of the holding device according to the invention, it can be provided that the opening in the base plate is a circumferential, annular opening arranged at a distance from the outside edge and inside the outside edge of the base plate.

In one embodiment of the holding device according to the invention, it can be provided that the receiving space for the microchip substrate is radially outwardly-bounded by the frame.

In one embodiment of the holding device according to the invention, it can be provided that the height of the receiving space for the microchip substrate is determined by the distance between the surface of the base plate that faces the microchip substrate to be received or the surface of a seal that faces the microchip substrate, which seal optionally rests on the base plate, and the side of the frame that faces away from the base plate.

In one embodiment of the holding device according to the invention, it can be provided that in the base plate, at least one opening for the centering of the holding device is provided.

In one embodiment of the holding device according to the invention, there can be provided three openings for the passage of pins for raising the microchip substrate from the holding device, at least two openings for centering the holding device on an adapter, at least one opening for testing the seal of the applied polymer film, and at least one opening for applying underpressure and for ventilation, wherein at least one selected opening is provided for at least one, preferably two or three, of the above-mentioned functions.

In one embodiment of the holding device according to the invention, it can be provided that the frame is made of electrically-conductive material, in particular titanium or niobium, and, aside from two electrically-conductive areas of the surface, is coated in an electrically-insulating manner.

In one embodiment of the holding device according to the invention, it can be provided that the frame is made of electrically-insulating material, in particular ceramic or glass, and that the frame is coated in places in an electrically-conductive manner, in particular platinized.

In one embodiment of the holding device according to the invention, it can be provided that the opening in the base plate is provided in the area of the electrically-conductive coating of the frame.

In one embodiment of the holding device according to the invention, it can be provided that the frame and the base plate are made integral.

An embodiment of an adapter, with which the holding device according to the invention can be placed on a metallizing device, is disclosed and claimed.

Preferred and advantageous configurations of the adapter according to the invention are also disclosed and claimed.

In one embodiment of the adapter according to the invention, it can be provided that the connecting pins are designed to attach the adapter to a metallizing unit.

In one embodiment of the adapter according to the invention, it can be provided that electrical contact is made by the connecting pins to form an in particular annular contact sheet provided in the adapter.

In one embodiment of the adapter according to the invention, it can be provided that the connecting pins are made hollow and can be connected to a vacuum source.

In one embodiment of the adapter according to the invention, it can be provided that the base element of the adapter is made of electrically-conductive material.

In one embodiment of the adapter according to the invention, it can be provided that the base element of the adapter is made of electrically-insulating material and that an electrically-conductive ring is provided on the adapter to make electrical contact with the holding device.

In one embodiment of the adapter according to the invention, it can be provided that a seal is provided on the external periphery of the base element of the adapter.

In one embodiment of the adapter according to the invention, it can be provided that tongues are provided on the contact sheet.

In one embodiment of the adapter according to the invention, it can be provided that on the surface of the base element of the adapter facing the holding device, at least one centering projection, in particular two centering projections, is/are provided.

In one embodiment of the adapter according to the invention, it can be provided that the tongues of the contact sheet rest on a ring made of elastic material.

In one embodiment of the adapter according to the invention, it can be provided that the contact sheet is electrically connected to the base element of the adapter.

In one embodiment of the holding device according to the invention, an electrical strip conductor (conductor film with or without tongues), which connects the edge of the microchip substrate to the electrically-conductive surface of the frame of the holding device, is located between the polymer film and the microchip substrate, on the one hand (radially inward), and the frame of the holding device, on the other hand (radially outward).

In one embodiment, the polymer film covers the edge of the microchip substrate and the frame surrounding the microchip substrate and ensures the necessary seal.

In one embodiment, the polymer film adheres to the underlying components (frame and microchip substrate) and thus ensures a secure (chemical, since glued) seal.

In one embodiment of the holding device according to the invention, it is provided that in the base plate of the holding device, a circumferential opening is provided, so that an electrical conductor can be coupled directly to the frame of the holding device (contact sheet). In this case, it can be provided that the opening is arranged in such a way that it is arranged in the area of the electrically-conductive coating of the frame. This makes it possible for a contact sheet from below to be able to rest directly against the electrically-conductive coating of the frame in an electrically-conductive manner.

Consideration is also given in the invention to an embodiment of the holding device for the microchip substrate, which comprises a ring (without a base plate) that surrounds the microchip substrate from the outside. In this embodiment, the microchip substrate is held in place by the (annular and glued) polymer film. In this case, the polymer film acts as a bridge. This embodiment is taken into consideration in particular in the case of small microchip substrates.

In another embodiment of the holding device according to the invention, the base plate and the frame of the holding device are manufactured from one piece. As a material, for example, either an electrically-conductive material (with an electrically-conductive coating of at least one partial surface and an insulating coating of the other surface) or an electrically-non-conductive material (such as ceramic) with an electrically-conductive partial coating is provided.

The adapter provided within the framework of the invention is used to couple a holding device according to the invention to a device for wet-chemical treatment of microchip substrates, such as an electrolytic metallizing unit. Such an electrolytic metallizing unit can be a Raider™ unit of Applied Materials, Inc.

In one embodiment, the adapter according to the invention has a connecting pin (or two connecting pins), via which the adapter can be held in place on the unit for wet-chemical treatment of microchip substrates and can be brought into electrical contact.

In one embodiment, it is provided that the connecting pin of the adapter is provided with a through hole, so that it can serve as a connecting point for a vacuum.

In one embodiment, it is provided that the connecting pin is screwed into the base element of the adapter with an electrically-conductive ring between them, so that a good electrically-conductive contact is produced.

The outer edge of the adapter, i.e., the edge of the base element, is surrounded with a seal, so that, on the one hand, electrolytes of normal aggressivity are kept from being able to penetrate into the adapter, and, on the other hand, the holding device for the microchip substrate can be held in place by underpressure.

In the adapter, in one embodiment, an annular contact sheet is provided that has tongues or fingers (pins) that rest on a ring made of elastic material, so that they are cushioned and produce good electrical contact relative to the holding device attached (suctioned) to the adapter, in particular the frame of the holding device, for the microchip substrate.

Within the framework of the invention, the process of electrically connecting the connecting pins of the adapter to the microchip substrate can proceed as follows:
Connecting pin→
Base element/inlay (this is an annular element made of electrically-conductive material, provided in the base element, which is made of electrically-insulating material)→
Or spring→base element/inlay→
Connecting arms of the contact sheet; instead of division into individual arms, a through conical plate ring could also be used→
Fingers of the contact sheet→
Electrically-conductive coating of the frame of the wafer holding device→Frame of the wafer holding device; if the latter is made of ceramic, the contact path runs solely via the electrically-conductive coating→
Electrical strip conductor (e.g., conductor film)→
Microchip substrate.

In one embodiment of the holding device according to the invention, two blind holes (recesses) are provided in the base plate of the holding device. The blind holes clearly serve to ensure unambiguous positioning and orientation of the holding device on the adapter. When the holding device is attached correctly to the adapter, cylindrical projections provided on the adapter engage in the blind holes.

Another opening for ventilation purposes can be provided. Also, an opening can be provided in the base plate of the holding device. Such openings can be advantageous in particular during vacuum-lamination of the polymer film on a microchip substrate inserted into the holding device.

The holding device according to the invention for a microchip substrate in the case of its wet-chemical treatment can have the features cited below by way of example or combinations of at least one of these features with another feature or several other features:

The holding device can contain a frame, which surrounds the microchip substrate.

The frame can be made of an electrically-conductive or electrically-insulating material.

When the frame is made of an electrically-insulating material, at least a partial surface of the frame is coated in an electrically-conductive manner.

When the frame is made of an electrically-conductive material, at least a partial surface of the frame is coated in an electrically-conductive manner, and the other partial surface of the frame is coated in an electrically-insulating manner.

The frame can be made integral with the base plate, so that no connection (e.g., via gluing) of the frame to a base plate is necessary.

When frame and base plate are manufactured from one piece (e.g., carved out from a solid body or pressed into one), then the piece is made of electrically-conductive material, such as, e.g., titanium.

When frame and base plate are manufactured from one piece, no opening for making electrical contact is necessary in the base plate, but rather the contact sheet of the adapter can dock directly onto the (optionally coated) bottom of the piece.

When frame and base plate are manufactured from one piece, at least one electrically-conductive coated partial surface and one electrically-insulating coating of the other surface of the piece can be provided.

In one embodiment, the holding device is made only of a frame (without a base plate). The connection to the microchip substrate is then achieved exclusively via the functionalized polymer film.

When, in one embodiment of the holding device, a separate base plate made of electrically-insulating material is used, the base plate can be provided with a circumferential opening, so that the contact sheet of the adapter can rest against the frame or an electrically-conductive coating of the frame.

The upper surface of the frame or the surface of the holding device surrounding the microchip substrate, which lies on the wet-chemical side of the microchip substrate to be treated, aligns with the surface of the microchip substrate to be treated.

The frame or the component manufactured in one piece (frame and base plate) can be radially rounded externally.

The polymer film can extend up to the beginning of the rounding.

When the base plate is provided, the latter can have at least one borehole, e.g., for ventilation or as an opening for centering projections of the adapter.

The adapter according to the invention can have the features that are cited below by way of example, or combinations of at least one of these features with another feature or multiple other features:

The base element of the adapter can be manufactured from electrically-conductive material.

A base element made of electrically-conductive material can be coated in an electrically-insulating manner in places.

The base element can be manufactured from electrically-insulating material when another, separate part (“inlay”) made of electrically-conductive material, optionally with a coating, is inserted into the base element.

At least one connecting pin has a borehole, so that a vacuum line can be connected.

The adapter is encased at least on the side wall and radially outward on the side toward the holding device with a “soft” seal.

A spring can be arranged between the connecting pin and the base element or between the connecting pin and an inserted electrically-conductive component (with or without a coating).

The top of the adapter that faces the holding device is provided with at least one circumferential recess and at least one linear recess (groove).

A circumferential contact sheet can be provided on the adapter, which sheet extends beyond the surface of the “soft” seal.

The adapter can contain an elastomer ring.

The profile of the elastomer ring is designed in such a way that the fingers (tongues) of the contact sheet are kept in contact elastically with an attached holding device.

The contact sheet can be fastened via at least one connecting arm.

The contact sheet can be designed conically in places, wherein the fastening of the contact area to the base element of the adapter is done via boreholes in the conical part.

On the side of the adapter facing the holding device, at least one projection that projects over the contact sheet can be provided in order to center the holding device.

By using a polymer film for sealing the edge of the microchip substrate, in addition to the edge of the microchip substrate making electrical contact, the pronounced topography level in the state of the art is almost completely eliminated at the edge of the microchip substrate. This is advantageous for wet-chemical processes, since a pronounced topography level considerably disrupts the flow of electrolytes and adversely affects the result of the treatment, in particular on the edge of the microchip substrate.

The known solutions for making contact with the edge and sealing the edge (clamping devices) offer no option for further reducing the topography level. By the current described method according to the invention and the holding device according to the invention, on the one hand, the topography level can be considerably reduced, and, on the other hand, the option is provided of making the edge narrower than previously.

The polymer film used in the method according to the invention can be made of, for example, (PET), (PE), (PP), or (PMP).

When the polymer film used in the method according to the invention has two or more than two layers, it can have a layer that serves as a carrier, for example made of polyethylene terephthalate (PET), polyethylene (PE), polypropylene (PP), polymethylpentene (PMP), or polytetrafluoroethylene (PTFE). In the case of a multi-layer polymer film, the layer that serves as a carrier carries a layer that has an adhesive action. The layer with an adhesive action is made of, for example, a hot-melt adhesive based on a polyolefin (e.g., Henkel Technomelt AS 5303), made of a UV-settable, hot-melt adhesive, such as a dry lacquer, ethylene vinyl acetate (EVA), or a silicone adhesive.

The layer of polymer film that has an adhesive action can be covered by another layer that is used as a protective film. The protective film, which is removed, for example peeled off, before the polymer film is used, can be, for example, a layer made of polyethylene (PE).

Within the framework of the invention, consideration is given to the fact that the layer of polymer film that serves as a carrier can be removed, for example peeled off, before the wet-chemical treatment of the microchip substrate is carried out.

In addition, within the framework of the invention, consideration is given to applying the polymer film on the microchip substrate while leaving free the at least one area of the microchip substrate to be treated.

When, during the implementation of the method according to the invention, a polymer film is used that comprises a layer made of a dry lacquer, it is possible to proceed, for example, as follows:
Peeling off the protective film,
The thus obtained polymer film that has two layers is applied onto the holding device and over the entire surface of the microchip substrate, for example by lamination,
The layer that has adhesive action (dry lacquer) is set, for example, by UV radiation,
The layer of the polymer film that is used as a carrier is removed, for example, by peeling, Structuring of the dry lacquer via lithography processes in order to expose the at least one area of the microchip substrate to be treated, and
Implementing the wet-chemical treatment of the microchip substrate and the additional process steps.

When, in the method according to the invention, a conductor film is used as an electrical conductor, a conductor film that has at least one layer, preferably two or three layers, can be used.

For example, a conductor film has a layer made of PET and a layer made of electrically-conductive material, e.g., copper.

Another embodiment of the conductor film has a layer made of PET that carries two-sided layers made of an electrically-conductive material, e.g., copper.

When, in the method according to the invention, a conductor film is used as an electrical conductor, the latter is arranged on the side of the polymer film close to the microchip substrate to be treated. In general, the conductor film that is used is embedded at least partially into the polymer film since it is pressed into the polymer film during application onto the polymer film. The conductor film is preferably applied before the polymer film is applied onto the microchip substrate and before the holding device is applied to the side of the polymer film facing the microchip substrate, in order to functionalize the polymer film.

### BRIEF DESCRIPTION OF THE DRAWINGS

Additional details and features of the invention are given in the description below of preferred implementation examples and embodiments, in which reference is made to the accompanying drawings. Here:

FIG. 1 shows a flow chart with the exemplary sequence of the method according to the invention,

FIG. 2 shows, in an oblique view, an embodiment of the holding device according to the invention, which is loaded with a microchip substrate,

FIG. 3 shows an embodiment of a conductor film,

FIG. 4 shows another embodiment of a conductor film, device,

FIG. 5 shows, in section, the assignment of polymer film and conductor film to a holding

FIG. 6 shows, partially, a section of a loaded and filmed holding device, substrate,

FIG. 7 shows, in an oblique view, a holding device that is not loaded with a microchip

FIG. 8 shows a top view relative to FIG. 7,

FIG. 9 shows, above, a topography level of the state of the art, and, below, a topography level of the method according to the invention,

FIG. 10 shows an adapter in an oblique view,

FIG. 11 shows a detail of the adapter in section,

FIG. 12 shows, in an oblique view, a detail of the adapter, enlarged,

FIG. 13 shows an adapter and a holding device with a microchip substrate (partial),

FIG. 14 shows an adapter with—for the sake of clarity at a distance—a holding device arranged above with a microchip substrate (in an oblique view and partially), and

FIG. 15 shows, in section, an adapter with a holding device, arranged above, with a microchip substrate.

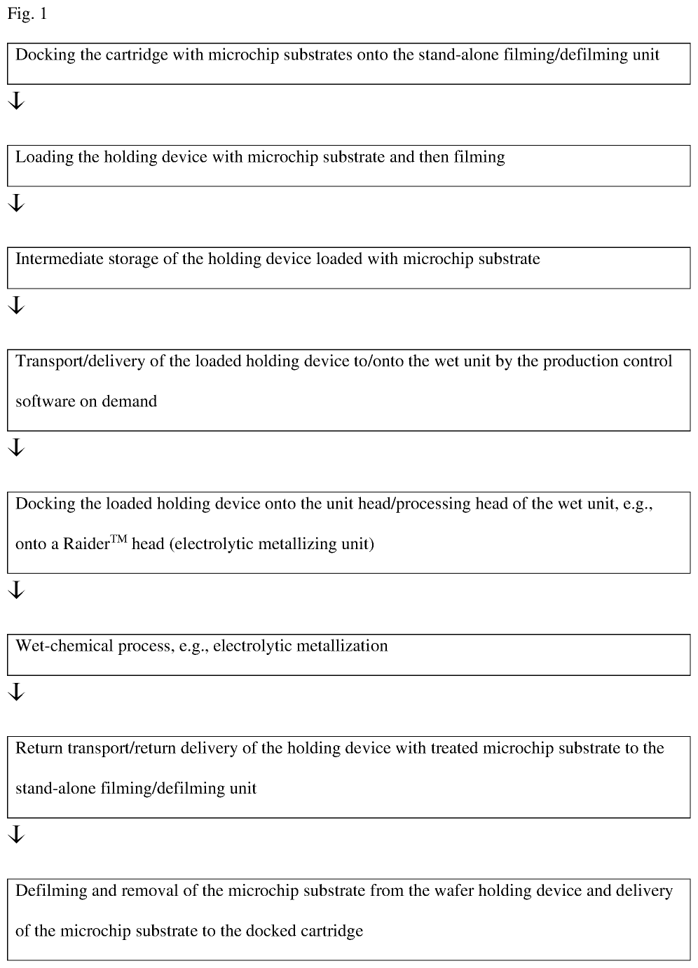

### DETAILED DESCRIPTION

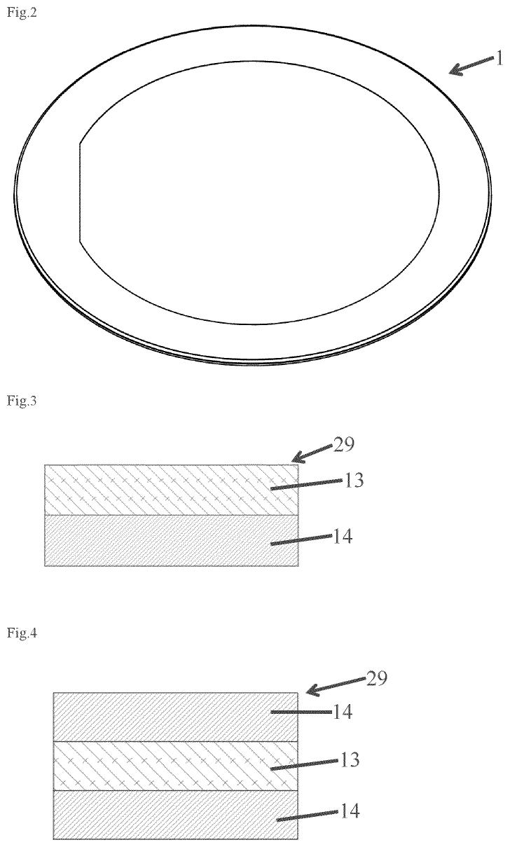

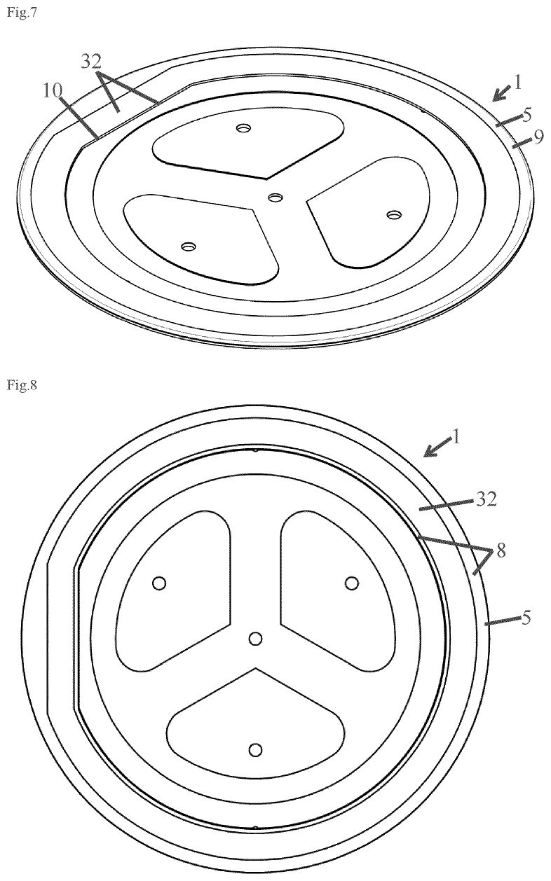

A holding device 1, shown in FIGS. 2 and 6, loaded with a microchip substrate and provided with a polymer film (“filmed”) for a microchip substrate 2, such as a wafer or a panel, comprises, in the embodiment shown, a base plate 3, in which a, for example, circumferential (annular) opening 4 is provided. In particular, a polymer film 7 is used, which is functionalized by at least one strip conductor applied onto the polymer film, such as a conductor film 29. A frame 5 is glued via a layer 34 to the outer area 12 of the base plate 3, which layer outwardly bounds a receiving space 6 for a microchip substrate 2. In FIG. 6, it is shown that a polymer film 7 is arranged, namely glued, to the microchip substrate 2—covering the outer edge area of the microchip substrate 2—and to the frame 5.

In the base plate 3, additional openings can be provided—aside from the opening 4 allowing electrical contact to be made with the frame 5. Additional openings can be provided for centering the holding device 1, for attaching the microchip substrate 2 by underpressure, for loading the holding device 1 with a microchip substrate, for unloading the holding device 1, and for testing the seal of the filming (applied polymer film 7).

In this case, it is provided in particular that at least two openings are provided, in which projections 26 of an adapter 15 engage when the holding device 1 is positioned correctly on the adapter 15.

In addition, at least one opening for the testing of the seal of the applied polymer film 7 can be provided in the base plate 3.

For applying underpressure in order to attach a microchip substrate 2 to the holding device 1, at least one opening can be provided in the base plate 3. This opening can also be used for ventilation.

Moreover, at least three openings can be provided in the base plate, through which openings pins can extend, in order to raise a microchip substrate 2 from the holding device 1.

Within the framework of the invention, consideration is given to using individual or multiple above-mentioned openings even for two or more of the above-mentioned functions.

In the embodiment, shown in FIG. 7, of the unloaded holding device 1, the frame 5 is made of an electrically-insulating material (e.g., ceramic), wherein its surface 9 carries an electrically-conductive layer 32. The electrically-conductive layer 32 extends from the side pointing upward in FIG. 7 over the inner edge surface 10 of the frame 5 up to the side of the frame 5 pointing downward in FIG. 7.

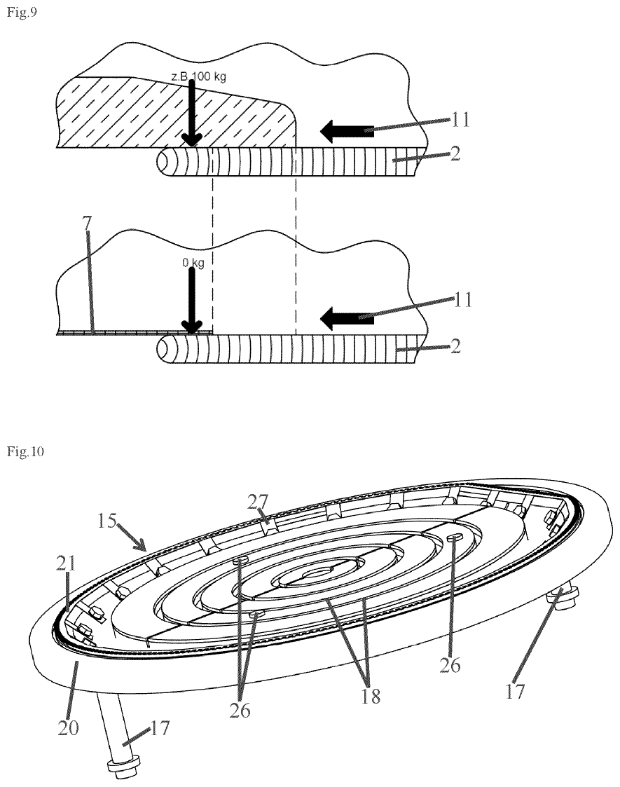

FIG. 8 shows another embodiment of the holding device 1 according to the invention (not loaded), in which the frame 5 is made of electrically-conductive material, wherein two surfaces that are separated from one another, namely the surface pointing upward toward the microchip substrate (which is the surface of the frame 5, which preferably at least essentially lies in a plane with the surface of the microchip substrate) and the downward-pointing surface of the frame 5, carry an electrically-conductive layer 32. Electrically-insulating layers 8 are applied onto the inner edge and onto the outer edge of the frame 5.

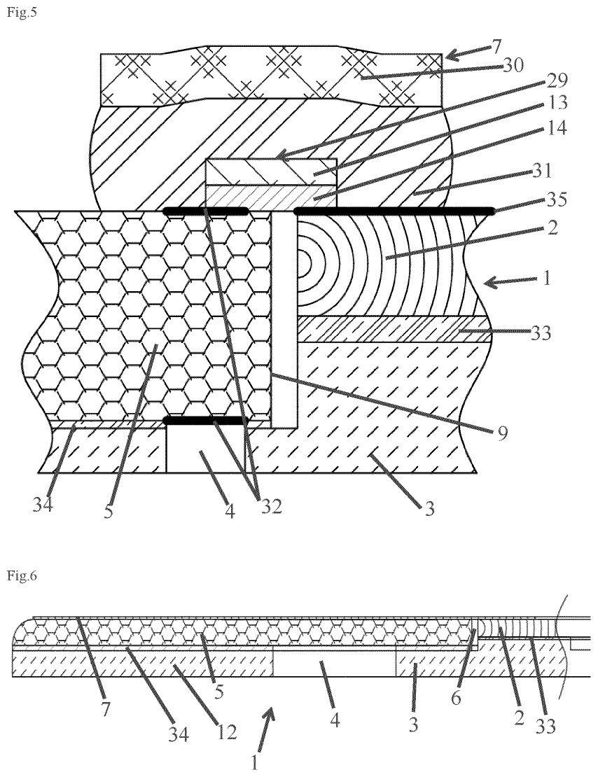

In order to produce an electrically-conductive connection between the frame 5 of the holding device 1 and the conductive layer 35 of the microchip substrate 2, a conductor film 29 is assigned to, for example, the polymer film 7. Examples of conductor films 29 are shown in FIGS. 3 and 4. The conductor film 29 of FIG. 3 consists of a carrier film 13 made of a plastic and an electrically-conductive layer 14 (e.g., copper). In the embodiment of the conductor film according to FIG. 4, the carrier film 13 is accommodated between two electrically-conductive layers 14.

FIG. 5 shows that the conductor film 29 made of a carrier film 13 and an electrically-conductive layer 14 in the polymer film 7, which conductor film comprises a layer used as a carrier 30 and a layer 31 having an adhesive action in the example shown, is pressed in after the filming. This results from the pressing force during the application of the conductor film 29 on the polymer film 7. Preferably, the conductor film 29 is applied (laminated) on the frame 5 of the holding device 1 and the microchip substrate 2 before the application (“filming”) of the polymer film, e.g., by lamination.

In FIG. 9, it is shown in the upper area how the topography level is designed in the state of the art and that considerable forces are necessary in order to press the edge structure for making electrical contact and for sealing the microchip substrate arranged below. Also, for this purpose, a larger (broader) area is necessary. In addition, the direction of flow of the electrolyte is depicted by an arrow 11.

In the method according to the invention, no force is necessary in order to keep the polymer film 7 in contact on the edge of the microchip substrate 2 (wafer), since the latter is connected, e.g., glued, to the edge of the microchip substrate. Also, a narrower area in which the polymer film 7 is arranged extending above the wafer is sufficient.

Within the framework of the invention, the term polymer film 7 is defined as a plastic film that is made of, for example, one of the plastics mentioned above and that can have the design mentioned above.

The depiction of FIG. 6 shows that the receiving space 6 for the microchip substrate 2, which is bounded downward by the base plate 3 and outward by the frame 5, has a height that corresponds essentially to the thickness of the microchip substrate 2. In particular, the height is the same as the thickness of the microchip substrate 2.

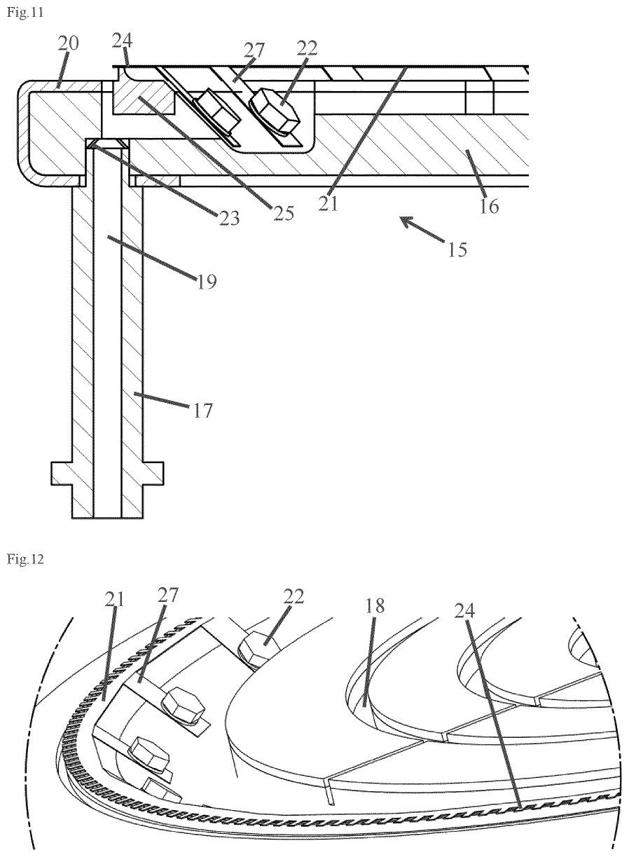

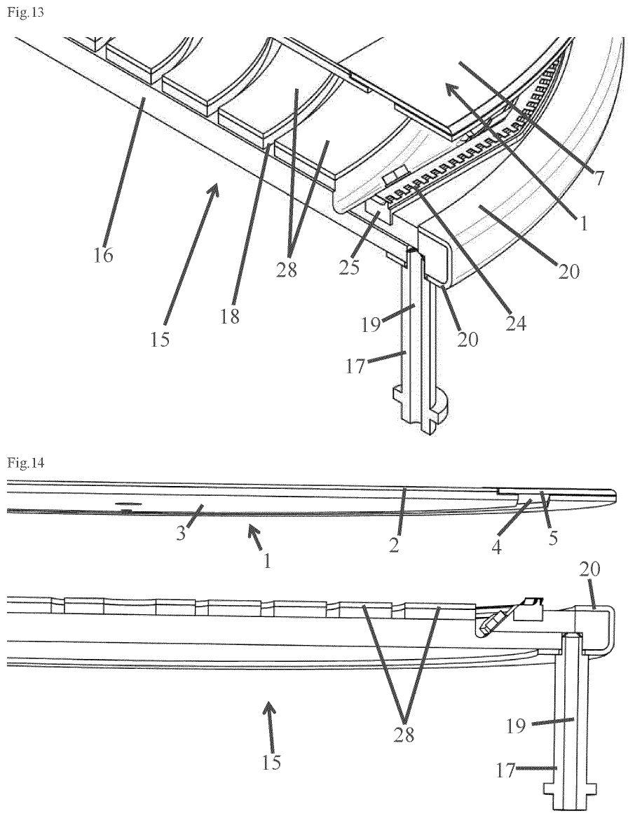

An adapter 15 shown in FIGS. 10 to 12, with which a holding device 1 according to the invention can be attached to a unit for wet-chemical treatment, comprises a base element 16, in which two connecting pins 17 are provided. In the surface of the base element 16 close to the holding device 1, annular recesses 18 are provided in the example shown, which recesses can be supplied with underpressure via through holes 19 in the connecting pins 17 in order to attach a holding device 1 to the adapter 15 and optionally to attach the microchip substrate to the base plate 3 of the holding device 1 with underpressure.

The outside edge of the base element 16 of the adapter 15 is provided with a seal 20, so that the inner area of the adapter 15 is protected against the penetration of aggressive electrolytes.

In the adapter 15, a circumferential contact sheet 21 is provided, which is fastened via screws 22 and connecting arms 27 to the base element 16 of the adapter 15 made of, for example, electrically-conductive material.

The connecting pins 17 are screwed into the base element 16 with a cup spring 23 in between, so that the latter is electrically connected to the base element 16—and thus also to the annular contact sheet 21.

The contact sheet 21 has tongues 24 (contact pins), which rest on a ring 25 made of elastic material (cf. FIG. 11).

In the surface of the base element 16 of the adapter 15 that faces the holding device 1, three projections 26 are provided in the embodiment shown. The projections 26 engage in openings in the base plate 3 of the holding device 1 when the holding device 1 is correctly positioned on the adapter 15.

The mutual assignments of the holding device 1 and the adapter 15 according to the invention are shown in FIGS. 13 to 15. In FIGS. 13 to 15—for the sake of clarity—a distance between the holding device 1 loaded with a microchip substrate and the adapter 15 is depicted. In the operating position, the holding device 1 according to the invention rests, at least with the outer area 12 of its base plate 3, i.e., in an area 12 outside of the opening 4, against the seal 20, on the outside edge of the adapter 15. In addition, in the central area of the adapter 15, sealing surfaces 28 are provided, on which the base plate 3 of the holding device 1 rests with its central area.

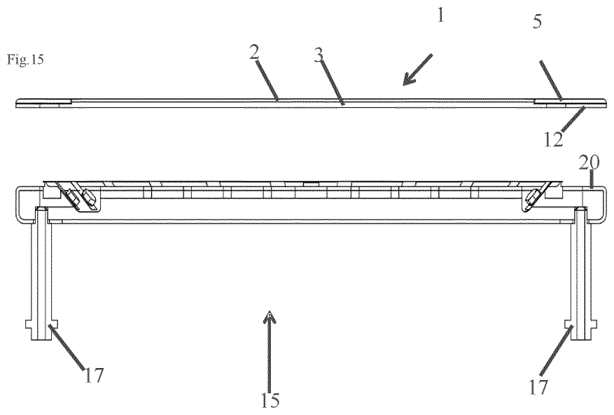

It is evident from the depiction of FIG. 14 that the tongues 24 of the contact sheet 21 are assigned to the (annular) opening 4 of the base plate 3 of the holding device 1, so that the tongues 24 in the holding device 1 resting against the adapter 15 extend through the opening 4 and rest in an electrically-conductive manner against the frame 5 of the holding device 1.

In the diagrammatic depiction, not to scale, in FIG. 5, it is shown by way of example how a microchip substrate 2 can be arranged on a holding device 1. FIG. 5 also shows that the conductor film 29 that surrounds the carrier film 13 and the electrically-conductive layer 14 is arranged in such a way that an electrically-conductive connection is provided between the electrically-conductive layer 35 of the microchip substrate 2 and the frame 5 of the holding device 1.

In summary, an example of the invention can be described as follows:

Described is a method for wet-chemical treatment of microchip substrates 2, wherein the microchip substrates 2 are inserted into a holding device 1. The holding device 1 is docked using an adapter 15 onto a unit for wet-chemical treatment, such as metallization.

1. Method for wet-chemical treatment of a microchip substrate,
the method comprising:
Loading a holding device with at least one microchip substrate, wherein the holding device surrounds the microchip substrate,
Applying a polymer film onto the area of the holding device that surrounds the microchip substrate and onto the microchip substrate,
Producing an electrical connection between the microchip substrate and the area of the holding device surrounding the microchip substrate,
Executing the wet-chemical treatment,
At least partially removing the polymer film from the microchip substrate arranged in the holding device, and
Extracting the treated microchip substrate from the holding device, wherein the steps of loading the holding device, applying the polymer film, producing the electrically-conductive connection, removing the polymer film, and extracting the microchip substrate are executed independently of the wet-chemical treatment.

2-4. (canceled)

5. The method according to claim 1, wherein the polymer film is attached when the polymer film is glued on with the input of heat and application of pressing force, the heat being generated by means of laser radiation.

6-7. (canceled)

8. The method according to claim 5, wherein the pressing force is applied using a laser-permeable die is used.

9-11. (canceled)

12. The method according to claim 1, wherein a polymer film is used, which film as a strip conductor has a conductor film comprising a carrier film and at least one electrically-conductive layer.

13-14. (canceled)

15. The method according to claim 1, wherein as a polymer film, a dry-lacquer film is used.

16-19. (canceled)

20. The method according to claim 1, wherein a polymer film is used, which film as a strip conductor carries an annular conductor film, the annular conductor film being connected to the polymer film by gluing.

21. The method according to claim 1, wherein the polymer film and/or the conductor film is/are laser-trimmed.

22. (canceled)

23. The method according to claim 1, wherein the removal of the polymer film is done by laser.

24. The method according to claim 1, wherein the polymer film is removed chemically and/or mechanically.

25. The method according to claim 1, wherein at least one edge of the microchip substrate is cleaned after the polymer film is removed.

26. The method according to wherein the cleaning is done by means of laser.

27. The method according to claim 25, wherein the face, the back side, and the edge of the microchip substrate are cleaned.

28. The method according to one of claims 1 to 27, claim 1, wherein the holding device is loaded with two microchip substrates.

29. Holding device (1) for use during wet-chemical treatment of a microchip substrate, comprising a frame provided in the area of the outer edge of the holding device, a receiving space-bounded by the frame and optionally a base plate for a microchip substrate, wherein the frame is made of electrically-conductive material with at least one electrically-conductive coating and in addition to the at least one electrically-conductive coating with an electrically-insulating coating or electrically-insulating material with an electrically-conductive coating.

30. (canceled)

31. The holding device according to claim 29, characterized in wherein in the base plate, at least one opening is provided, which opening is covered by the frame or a microchip substrate, with which the holding device is loaded.

32.-35. (canceled)

36. The holding device according to claim 29, wherein in the base plate, at least three openings for the passage of pins for raising the microchip substrate from the holding device, at least two openings for centering the holding device on an adapter, at least one opening for testing the seal of the applied polymer and at least one opening for applying underpressure and for ventilation are provided, wherein at least one selected opening is provided for at least one of the above-mentioned functions.

37. The holding device according to claim 29, wherein the frame is made of electrically-conductive material, aside from two electrically-conductive areas of the surface, is coated in an electrically-insulating manner.

38. (canceled)

39. The holding device according to claim 31, wherein the opening in the base plate is provided in the area of the electrically-conductive coating of the frame.

40. (canceled)

41. Adapter for connecting a holding device according to claim 29 to an electrolytic metallizing unit, comprising a base element with two connecting pins, seal to be applied to the holding device, and sealing surfaces to be applied to the holding device, and recesses, to which underpressure can be applied, in the surface of the base element that faces the holding device to be received.

42. (canceled)

43. The adapter according to claim 41, wherein electrical contact is made by the connecting pins to form an annular contact sheet provided in the adapter.

44. The adapter according to claim 41, wherein the connecting pins are made hollow and can be connected to a vacuum source.

45-51. (canceled)
